(19) United States
(12) Patent Application Publication
(10) Pub. No.: US 2010/0274590 A1
(43) Pub. Date: Oct. 28, 2010

(54) INSURANCE ADMINISTRATION SYSTEMS AND METHODS

(76) Inventors: Jeffrey B. Compangano, Aliso Viejo, CA (US); David Duker, Laguna Beach, CA (US)

Correspondence Address: BAKER & HOSTETLER LLP, WASHINGTON SQUARE, SUITE 1100, 1050 CONNECTICUT AVE. N.W., WASHINGTON, DC, 20036-5304, US

(21) Appl. No.: 12/766,843

(22) Filed: Apr. 23, 2010

Related U.S. Application Data
(60) Provisional application No. 61/172,387, filed on Apr. 24, 2009.

(51) Int. Cl. G06Q 40/00; G06Q 50/00; G06F 17/24

(52) U.S. Cl. 705/3; 705/4; 715/226

(57) ABSTRACT

Insurance administration systems and methods including computer-accessible administration portals are disclosed. Some exemplary embodiments may include computer-accessible administration portals that are accessible after an insurance benefits package has been purchased. Some exemplary embodiments may provide post-sale functions, such as providing forms, quotes, and information associated with a previously purchased insurance benefits package.

### CROSS REFERENCE TO RELATED APPLICATIONS

This application claims the benefit of U.S. Provisional Application No. 61/172,387, filed Apr. 24, 2009, which is incorporated by reference.

### BACKGROUND

The present disclosure is directed to insurance administration systems and methods and, more particularly, to computer-accessible administration portals.

### SUMMARY

Exemplary embodiments may include insurance administration systems and methods, including computer-accessible administration portals. Some exemplary embodiments may include computer-accessible administration portals that are accessible after an insurance benefits package has been purchased. Some exemplary embodiments may provide post-sale functions, such as providing forms, quotes, and information associated with a previously purchased insurance benefits package.

In an aspect, a system for administering insurance benefits may include a computer system; one or more server systems in communication with the computer system; and an administration portal provided on the one or more server systems, the administration portal being configured to provide information related to one or more predetermined insurance benefits packages, the information pertaining to coverage options available under the one or more predetermined insurance benefits packages; where the administration portal is accessible by the computer system after the one or more predetermined insurance benefits packages have been selected, identified, or purchased.

In a detailed embodiment, the administration portal may not be accessible by the computer system before the one or more predetermined insurance benefits packages have been selected, identified, or purchased. In a detailed embodiment, the administration portal may be configured to provide substantially real-time quote associated with the one or more predetermined insurance benefits packages based, at least in part, on input from at least one of a client, an insurance broker and a stored client profile.

In a detailed embodiment, the administration portal may be configured to allow access to at least one document or form related to insurance administration and/or the administration portal may be configured to transmit the at least one document or form to the computer system upon request. In a detailed embodiment, the administration portal may be configured to receive an executed form from the computer system and to transmit the executed form to at least one of an insurance broker, an insurance company, a third party administrator, a government agency, a financial institution and a debit/credit card processor.

In a detailed embodiment, the administration portal may be in communication with a forms component, the forms component including a forms library database and an auto-populated forms component, the auto-populated forms component being configured to automatically pre-fill at least some data into at least one form provided to the computer system by the administration portal.

In a detailed embodiment, the computer system may include a client computer system and/or the administration portal may be in communication with a banking institution and a third party administrator. In a detailed embodiment, the banking institution may be associated with administration of at least one of a health debit card account and a health saving account.

In an aspect, an administration portal for insurance benefits may include an administration portal front end, the administration portal front end being configured to communicate with at least one computer system via a network; an administration portal management database operatively connected to the administration portal front end; and at least one content database including data associated with at least one of available coverage selections, rate schedules, client profiles, quote reports, and provider searches pertaining to a previously purchased insurance benefit; where the administration portal front end is configured to communicate with the at least one computer system after the previously purchased insurance benefit has been purchased.

In a detailed embodiment, the computer system may include at least one of a broker computer system and a client computer system. In a detailed embodiment, the administration portal may not be accessible by the computer system before the previously purchased insurance benefits have been purchased.

In an aspect, a computer-readable medium may include program code for implementing a method including, after selling a selected insurance benefit to a client, providing a computer-accessible administration portal, the computer-accessible administration portal providing at least one of information and documents associated with the selected insurance benefit, the information and documents including at least one available selection or change of insurance coverage available under the selected insurance benefit.

In a detailed embodiment, at least one of the information and documents may include a quote generated substantially in real-time based at least in part on data pertaining to the selection or change of insurance coverage provided under the selected insurance benefit. In a detailed embodiment, providing the computer-accessible administration portal may include providing information associated with at least one of health care providers, pharmacies, pharmaceuticals, health and wellness, government benefits, broker service centers, and insurance company service centers.

In a detailed embodiment, the method may include transmitting, to the client via the administration portal, a form including at least some pre-filled data. In a detailed embodiment, the method may include receiving, from the client via the administration portal, an executed version of the form.

In a detailed embodiment, the method may include at least one of collecting, storing, and analyzing at least one of health records, health account balances, account claims, and health-related data. In a detailed embodiment, the method may include establishing a chat session between at least two of a client, a broker, and an insurance company representative via the computer-accessible administration portal.

### BRIEF DESCRIPTION OF THE DRAWINGS

The detailed description refers to the following figures in which:

FIG. 1 is a block diagram illustrating an exemplary insurance administration system and/or method;

FIG. 2 is a block diagram illustrating an exemplary insurance administration system and/or method;

FIG. 3 is a block diagram illustrating an exemplary insurance administration system and/or method;

FIG. 4 illustrates an exemplary report showing a generated quote;

FIG. 5 illustrates an exemplary report showing a generated quote;

FIG. 6 illustrates an exemplary enrollment worksheet for an employee;

FIG. 7 is a block diagram illustrating an exemplary insurance administration system and/or method;

FIG. 8 is a block diagram illustrating features of an exemplary insurance administration system and/or method; and

FIG. 9 illustrates an exemplary method of administering an insurance benefit; all in accordance with at least some aspects of the present disclosure.

### DETAILED DESCRIPTION

It should be understood that the following detailed description of exemplary embodiments is exemplary in nature and is not intended to constitute limitations upon the disclosure. It is also to be understood that variations of the exemplary embodiments contemplated by one of ordinary skill in the art shall concurrently fall within the scope and spirit of the disclosure. Although certain aspects of the exemplary embodiments are shown in more detail, some features within the purview of one skilled in the art may have been omitted for the sake of clarity and brevity.

The present disclosure includes, inter alia, insurance administration systems and methods, such as computer-accessible administration portals.

The present disclosure contemplates that, as costs related to insurance benefits rise, it may be beneficial for insurance companies, brokers, and/or clients to reduce administrative operating costs. Further, some clients may desire immediate access (e.g., via the internet) to information and details related to purchased and/or available insurance benefits.

The present disclosure contemplates that, additionally, some benefits programs have become increasingly complex. As such, brokers and/or clients may benefit from accurate and/or easy to understand information related to benefits programs and/or options. Further, accurate and/or timely resolution of benefits program coverage questions and/or issues may be beneficial to brokers and/or insurance companies. Some efficient benefits programs may also include resources for assuring prompt access to appropriate medical care to avoid potential incidents that may lead to expensive litigation due to failure accurately and/or timely respond to client questions.

The present disclosure contemplates that, currently, some insured clients may receive voluminous and confusing paperwork (such as printed brochures, forms kits, certificates of insurance, explanations of coverage, policies, procedures, manuals, etc.) from each and every insurance company they contract with (one set for each health insurer, one set for dental, one set for vision, etc.). This may result in some insured clients keeping hard copy files, which may be difficult to keep organized, complete, easily accessible, and/or up to date.

In some exemplary embodiments, an insurance administration system may include a network-based health-care benefits administration portal that may be set up by a health insurance broker and/or administrator for its clients (e.g., employer and/or individual clients) after an insurance policy sale has occurred. This post-sale administration portal may include data and resources that are customized specific to one or more benefits packages or related insurance that a client has purchased, identified, and/or selected, and may include that client's specific and current set rate schedules and/or specific enrolled benefits. The administration portal may allow the client and/or broker to generate benefit quotes for new employees and/or for employees whose personal status has changed, as well as when an individual client's personal status changes. By inputting a new employee's or individual's changed information or an existing employee's changed information into the portal, the system may process that information. Such processing may include generating a quote based upon the specific benefits packages and specific rate schedules that have previously been identified, purchased, and/or selected by the employer or individual. In addition, forms, brochures, customer service links, look-ups, and/or related support services may be bundled in a customized electronic file specific to the policies and/or coverages purchased. Some exemplary embodiments may include specific underwriting logic to assure that policy offerings are legally and/or commercially available to a specific employee, individual, and/or client.

In some exemplary embodiments, an insurance administration system may include a network-based health-care benefits administration portal that may be set up by a health insurance broker and/or administrator for its clients (e.g., employer and/or individual clients) after an initial sale has occurred and which may remain accessible during one or more benefits program renewal periods after the initial sale. In some exemplary embodiments, an administration portal may remain dynamic to allow life cycle changes.

In some exemplary embodiments, a web-based health benefits management portal that may be specifically customized (e.g., automatically) based upon specific benefits packages selected and/or purchased by an employer and/or individual. By tying such information and the portal with a quote engine programmed with rates and benefit descriptions of the specific insurance companies and/or benefits that the client has previously purchased, the portal may be capable of generating real-time (or near real-time) quotes based upon the specific health-benefits packages identified, purchased, and/or selected by the client. These generated quotes may subsequently be provided to the client electronically and/or in hard copy.

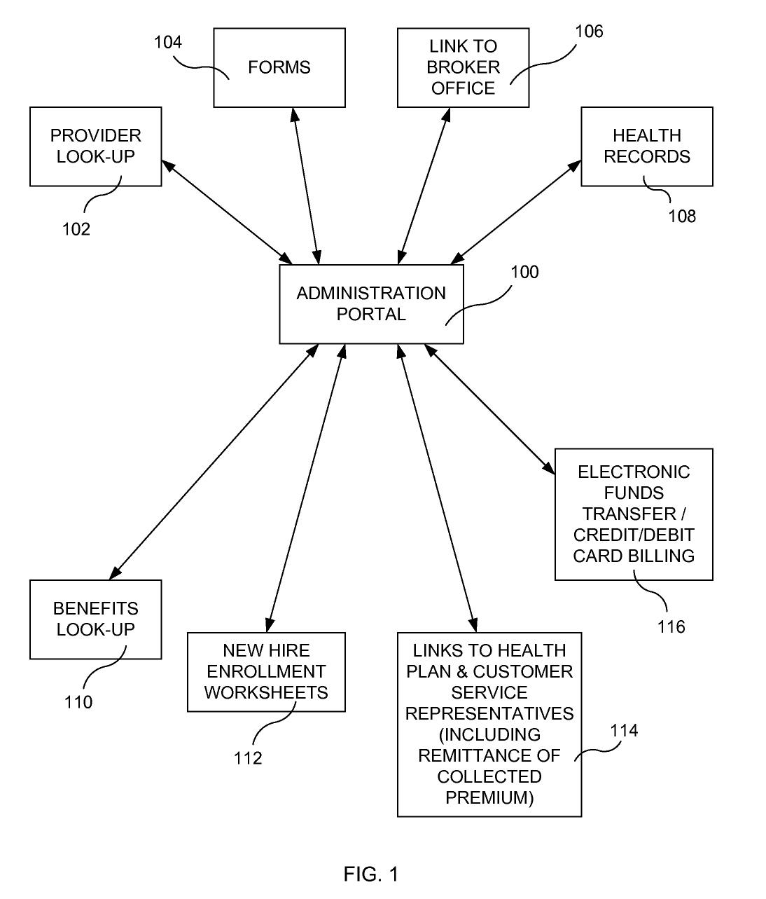

Referring to FIG. 1, an exemplary insurance administration system according to the present disclosure may include an administration portal 100, which may be operatively connected (e.g., able to send and/or receive data with) to one or more of a provider look-up component 102, a forms component 104, a link to one or more broker offices 106, a health records component 108, a benefits look-up component 110, a new hire enrollment worksheet component 112, one or more links to health plan and customer service representatives 114 (including, e.g., remittance of collected premiums), and/or an electronic funds transfer and/or credit/debit card billing component 116.

In some exemplary embodiments, administration portal 100 may provide forms and/or other related documentation specific to benefits package(s) chosen by a client. Such forms and/or related documentation may include, for example, claim forms, enrollment forms, policy change forms, address change forms, beneficiary change forms, and the like. In some exemplary embodiments, these forms may be provided electronically by administration portal 100.

In some exemplary embodiments, the customized, interactive, and/or password protection of this invention may support the collection, storage, and/or analysis of health records, health account balances, account claims, and/or other similar data. Additional features may allow clients to record, manage, and/or communicate health-related data to medical providers, insurers, third party administrators and/or financial institutions, as appropriate.

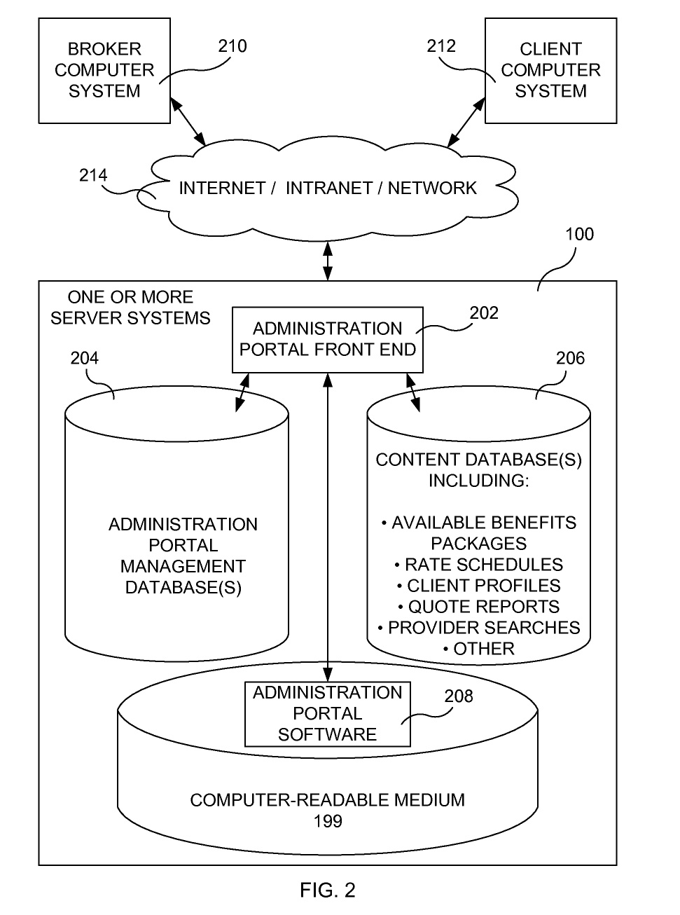

Referring to FIG. 2, in some exemplary insurance administration systems according to the present disclosure, administration portal 100 (which may be, for example, provided on one or more servers) may include an administration portal front end 202, one or more administration portal management databases 204, one or more content databases 206 (which may include, e.g., available benefits packages, rate schedules, client profiles, quote reports, provider searches, and/or other data), and/or one or more administration portal software components 208 (which may stored on one or more computer-readable media 199). Administration portal 100 may be communicatively connected to one or more broker computer systems 210 and/or one or more client computer systems 212, such as via a network 214 (e.g., the Internet, an intranet, etc.).

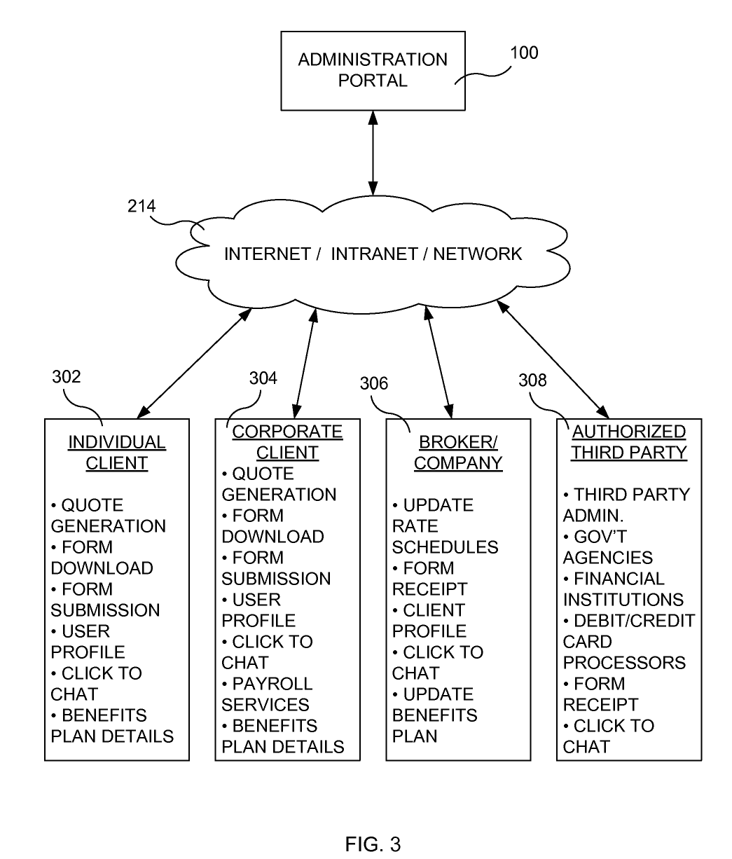

Referring to FIG. 3, in some exemplary insurance administration systems according to the present disclosure, administration portal 100 may be communicatively connected to one or more of an individual client 302, a corporate client 304, a broker/company 306, and/or an authorized third party 308, such as via network 214 (e.g., the Internet, an intranet, etc.). Individual client 302 may be provided with functions such as viewing, changing, requesting, and/or or interacting with quote generation, form download, form submission, user profile, click to chat, and/or benefits plan details. Corporate client may be provided with functions such as viewing, changing, requesting, and/or or interacting with quote generation, form download, form submission, user profile, click to chat, payroll services, and/or benefits plan details. Broker/company 306 may be provided with functions such as viewing, changing, requesting, and/or or interacting with update rate schedules, form receipt, client profile, click to chat, and/or update benefits plan. Authorized third party 308 may be provided with functions such as viewing, changing, requesting, and/or or interacting with third party administration, government agencies, financial institutions, debit/credit card processors, form receipt, and/or click to chat.

In some exemplary embodiments, administration portal 100 may be configured to allow for electronic exchange of documents and/or information directly among the client, insurance brokers, insurance companies, third party administrators, government agencies, financial institutions, debit/credit card processors, and the like. Specifically, administration portal 100 may provide for electronic submission of enrollment forms, change forms, and the like. One example of a broker-client information exchange may be the delivery of an insurance carrier's renewal proposal and/or proposed marketplace alternatives. These and other forms or information may be submitted electronically through administration portal 100. Further, administration portal 100 may also include functionalities to allow for electronic signatures, or the storage of hard copy forms, applications, and the like.

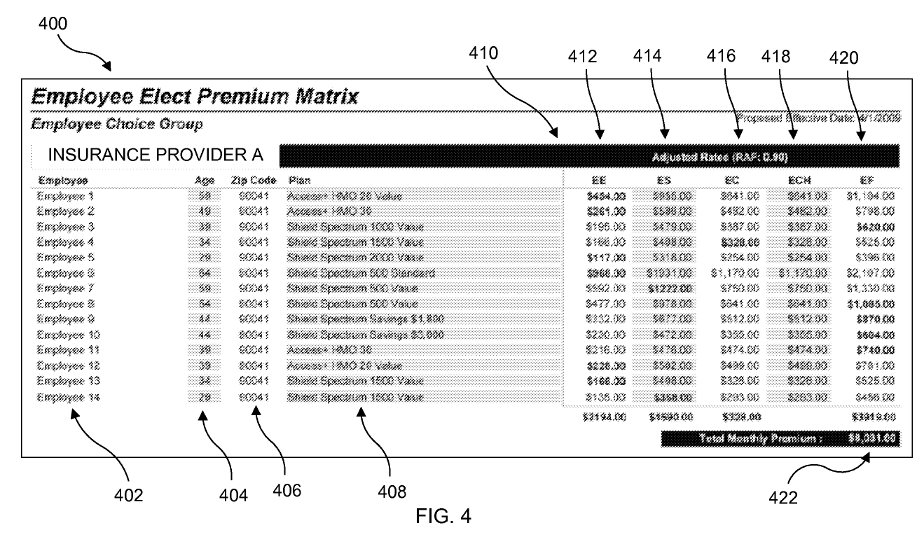

FIG. 4 illustrates an exemplary report 400 showing a generated quote associated with an Insurance Provider A benefits package. Report 400 may include a list of employees 402, employee data (e.g., age 404 and/or zip code 406), the plan 408 selected by each employee, and individual rate quotes 410 for each employee. For example, individual rate quotes 410 may include rates for the employee only 412, the employee plus spouse 414, the employee plus one child 416, the employee plus two or more children 418, and/or the family coverage 420. For each employee, the currently selected coverage may be indicated, such as by bold text, highlighting, etc. Quote 400 may include a total premium amount 422 for the group.

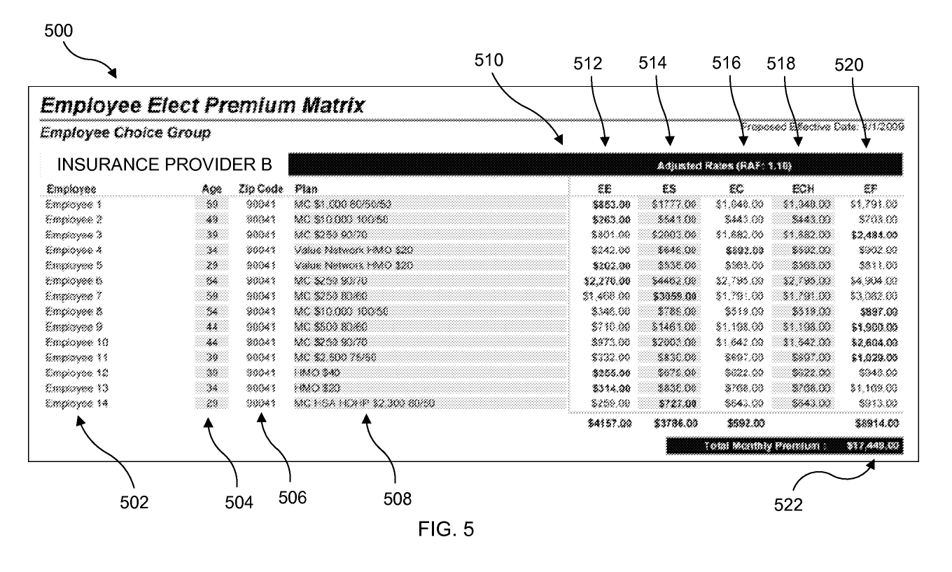

FIG. 5 illustrates an exemplary report 500 showing a generated quote associated with an Insurance Provider B benefits package. Report 500 may include a list of employees 502, employee data (e.g., age 504 and/or zip code 506), the plan 508 selected by each employee, and individual rate quotes 510 for each employee. For example, individual rate quotes 510 may include rates for the employee only 512, the employee plus spouse 514, the employee plus one child 516, the employee plus two or more children 518, and/or the family coverage 520. For each employee, the currently selected coverage may be indicated, such as by bold text, highlighting, etc. Quote 500 may include a total premium amount 522 for the group.

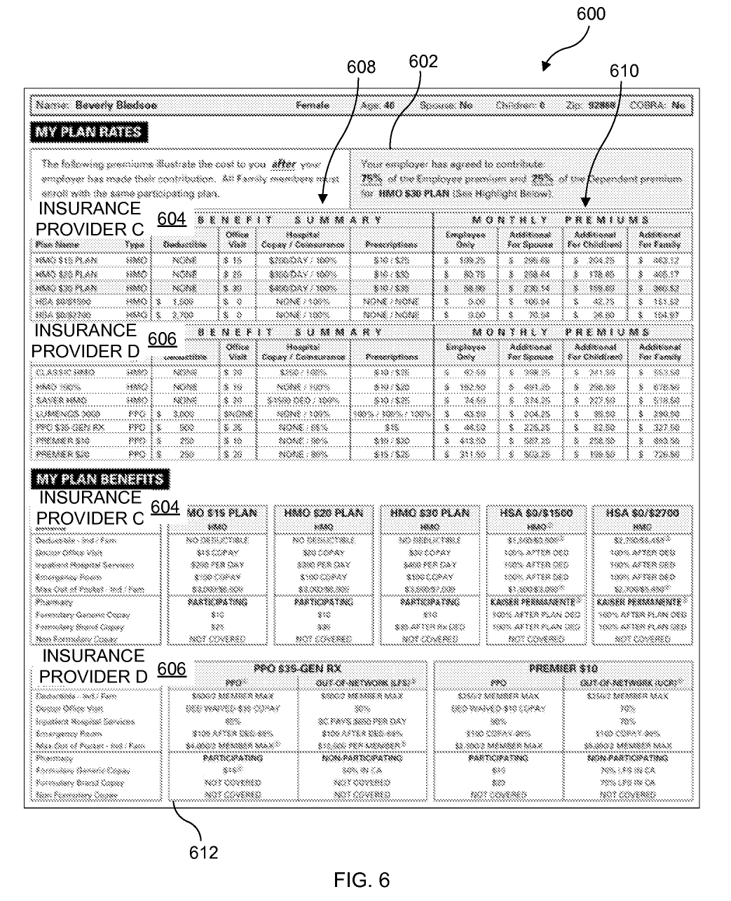

FIG. 6 illustrates an exemplary enrollment worksheet 600 for an employee whose employer offers a choice of health benefit plans provided by Insurance Provider C and Insurance Provider D. For example, worksheet 600 may include a rates section 602 which may include, for various plan choices provided by each of Insurance Provider C 604 and Insurance Provider D 606, a benefits summary 608 and/or monthly premiums 610. Similarly, a plan benefits section 612 may include information pertaining to the plan choices provided by each of Insurance Provider C 604 and Insurance Provider D 606.

In some exemplary embodiments, specific forms, information, links and other resources may be isolated in specific electronic file folders for each benefits package administered by the broker. In this way, the broker or administrator may easily automatically generate a customized administration portal 100 for each client, which may be accessible only by that client and the broker. Alternately, the client could self manage the process.

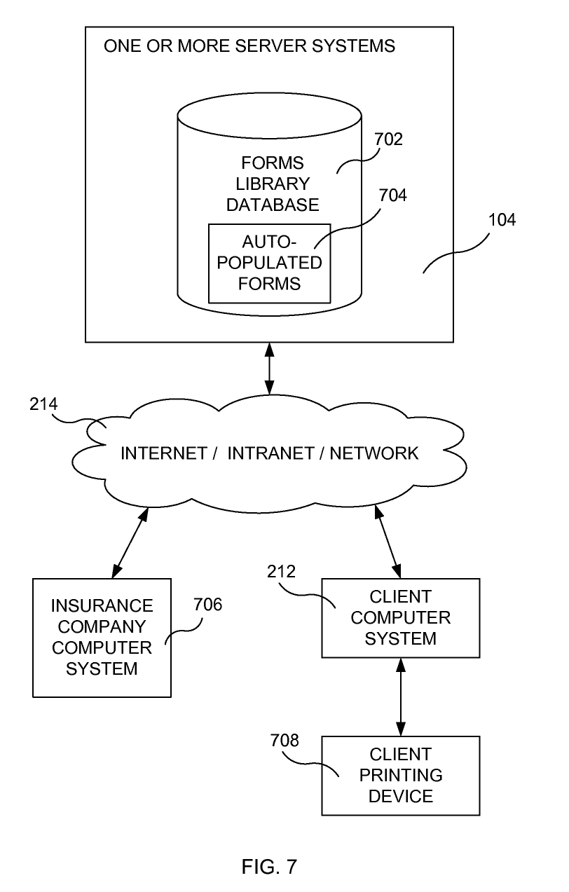

Referring to FIG. 7, in some exemplary insurance administration systems according to the present disclosure, forms component 104 may be provided on one or more servers and/or may include a forms library database 702, which may be operatively connected to an auto-populated forms component 704. Forms component 104 may be communicatively connected to one or more insurance company computer systems 706 and/or one or more client computer systems 212, such as via a network 214 (e.g., the Internet, an intranet, etc.). In some exemplary embodiments, client computer system 212 may be operatively connected to one or more client printing devices 708.

In some exemplary embodiments, administration portal 100 may include dynamic links between databases and forms to auto-populate the forms (as depicted in FIG. 7). Administration portal 100 may include Internet, intranet, or other network links related to various aspects of benefits administration. Some examples of these links may include links to identified, purchased, and/or selected health-benefits or related insurance package(s) details, provider and pharmacy and/or pharmaceutical look-ups, health and wellness information, government benefit information and/or health sites and links to the broker or insurance company service centers.

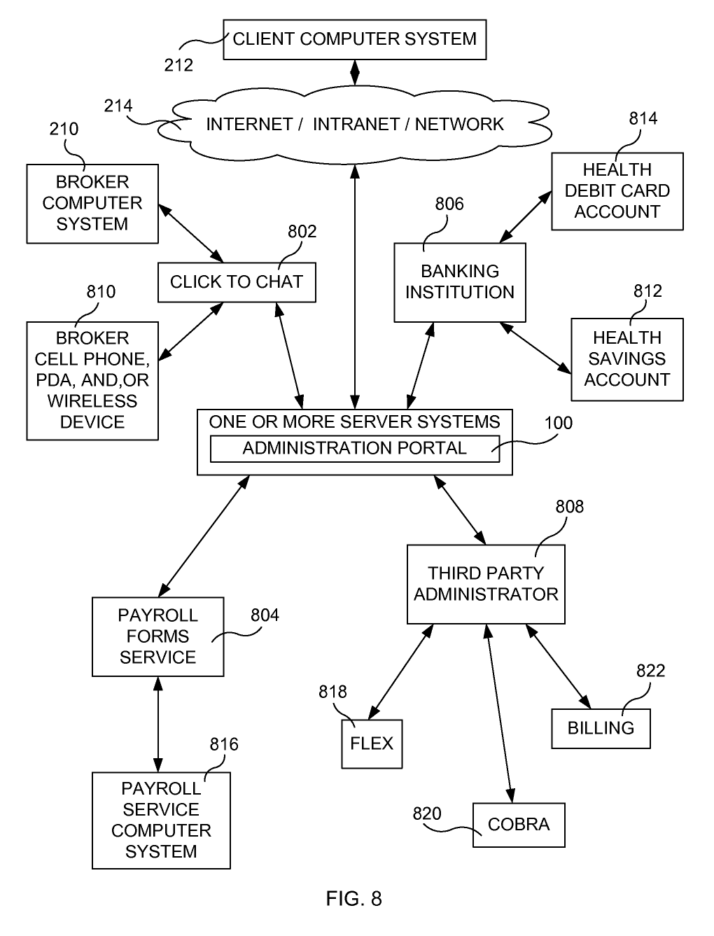

As depicted in FIG. 8, additional aspects of the invention may include Click to Chat 802, Payroll Forms Service 804, Banking Institution 806, and/or Third Party Administrator 808 features. An exemplary Click to Chat 802 feature may allows clients and/or brokers to initiate a chat session (e.g., using client computer system 212, broker computer system 210, and/or a broker cell phone, personal digital assistant (PDA), and/or wireless device 810) with insurance company representatives and/or brokers via administration portal 100. This chat session may assist clients with any questions they may have related to specific benefits packages, generated quotes, and/or other the portal contents. Further, Banking Institution 806 features may provide for HSA bank account 812 data to be made available to allow clients access to their account information and/or to perform online banking functions (transfers, deposits, electronic checks, etc.). Similarly, Banking Institution 806 features may allow clients to manage health debit card accounts 814. Additionally, Payroll Forms Service 804 features may provide for payroll vendors to be linked to administration portal 100, which may provide delivery of payroll data to a payroll processor and a simple interface for management of the payroll process, such as using payroll service computer system 816. In some exemplary embodiments, Third party administrator 808 features may include flexible spending account administration 818, COBRA benefit administration 820, and/or billing administration 822.

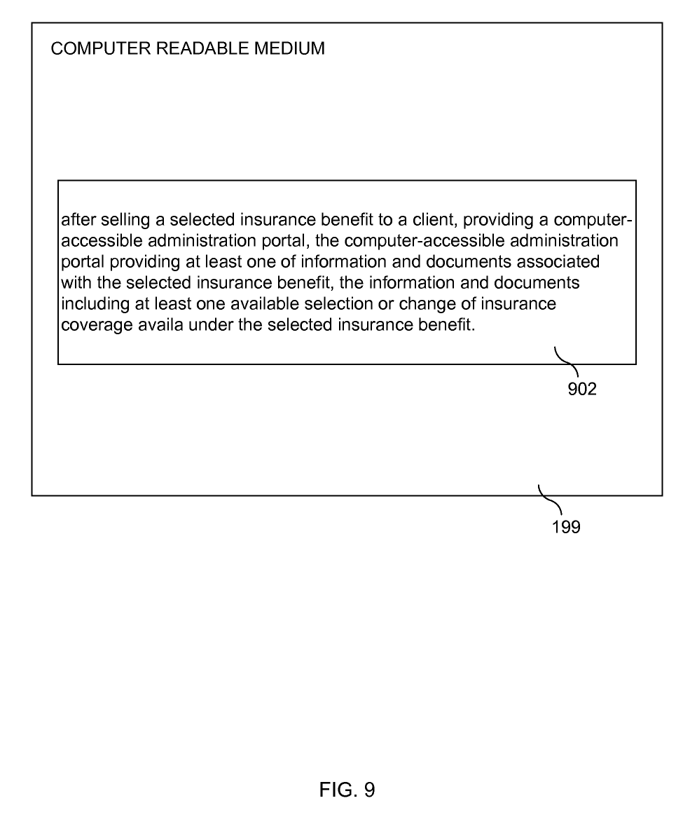

FIG. 9 illustrates a computer-readable medium including a computer-executable method of administering an insurance benefit. Operation 902 may include, after selling a selected insurance benefit to a client, providing a computer-accessible administration portal, the computer-accessible administration portal providing at least one of information and documents associated with the selected insurance benefit, the information and documents including at least one available selection or change of insurance coverage available under the selected insurance benefit. .

Some exemplary embodiments according to the present disclosure may provide a coupled, packaged, and integrated platform limited to and expressly for the convenient and dynamic management of health and health insurance administrative functionalities. Some exemplary embodiments according to the present disclosure may provide a system for administering insurance benefits and assisting with the orderly and efficient electronic management, benchmarking, maintenance, and renewal of health benefits.

To provide additional context for various aspects of the present invention, the following discussion is intended to provide a brief, general description of a suitable computing environment in which the various aspects of the invention may be implemented. While one embodiment of the invention relates to the general context of computer-executable instructions that may run on one or more computers, those skilled in the art will recognize that the invention also may be implemented in combination with other program modules and/or as a combination of hardware and software.

Generally, program modules include routines, programs, components, data structures, etc., that perform particular tasks or implement particular abstract data types. Moreover, those skilled in the art will appreciate that aspects of the inventive methods may be practiced with other computer system configurations, including single-processor or multiprocessor computer systems, minicomputers, mainframe computers, as well as personal computers, hand-held wireless computing devices, microprocessor-based or programmable consumer electronics, and the like, each of which can be operatively coupled to one or more associated devices. Aspects of the invention may also be practiced in distributed computing environments where certain tasks are performed by remote processing devices that are linked through a communications network. In a distributed computing environment, program modules may be located in both local and remote memory storage devices.

As used herein, the terms “component” and “system” are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. On or more components can reside within a process and/or thread of execution, and a component can be localized on one computer and/or distributed between two or more computers.

A computer may include a variety of computer readable media. Computer readable media may be any available media that can be accessed by the computer and includes both volatile and nonvolatile media, removable and non-removable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD ROM, digital video disk (DVD) or other optical disk storage, magnetic cassettes, magnetic tape, magnetic disk storage or other magnetic storage devices, or any other medium which may be used to store the desired information and which may be accessed by the computer.

An exemplary environment for implementing various aspects of the invention may include a computer that includes a processing unit, a system memory and a system bus. The system bus couples system components including, but not limited to, the system memory to the processing unit. The processing unit may be any of various commercially available processors. Dual microprocessors and other multi processor architectures may also be employed as the processing unit.

The system bus may be any of several types of bus structure that may further interconnect to a memory bus (with or without a memory controller), a peripheral bus, and a local bus using any of a variety of commercially available bus architectures. The system memory may include read only memory (ROM) and/or random access memory (RAM). A basic input/output system (BIOS) is stored in a non-volatile memory such as ROM, EPROM, EEPROM, which BIOS contains the basic routines that help to transfer information between elements within the computer, such as during start-up. The RAM may also include a high-speed RAM such as static RAM for caching data.

The computer may further include an internal hard disk drive (HDD) (e.g., EIDE, SATA), which internal hard disk drive may also be configured for external use in a suitable chassis, a magnetic floppy disk drive (FDD), (e.g., to read from or write to a removable diskette) and an optical disk drive, (e.g., reading a CD-ROM disk or, to read from or write to other high capacity optical media such as the DVD). The hard disk drive, magnetic disk drive and optical disk drive may be connected to the system bus by a hard disk drive interface, a magnetic disk drive interface and an optical drive interface, respectively. The interface for external drive implementations includes at least one or both of Universal Serial Bus (USB) and IEEE 1394 interface technologies.

The drives and their associated computer-readable media provide nonvolatile storage of data, data structures, computer-executable instructions, and so forth. For the computer, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods of the invention.

A number of program modules may be stored in the drives and RAM, including an operating system, one or more application programs, other program modules and program data. All or portions of the operating system, applications, modules, and/or data may also be cached in the RAM. It is appreciated that the invention may be implemented with various commercially available operating systems or combinations of operating systems.

A user may enter commands and information into the computer through one or more wired/wireless input devices, for example, a keyboard and a pointing device, such as a mouse. Other input devices may include a microphone, an IR remote control, a joystick, a game pad, a stylus pen, touch screen, or the like. These and other input devices are often connected to the processing unit through an input device interface that is coupled to the system bus, but may be connected by other interfaces, such as a parallel port, an IEEE 1394 serial port, a game port, a USB port, an IR interface, etc.

A display monitor or other type of display device may also be connected to the system bus via an interface, such as a video adapter. In addition to the monitor, a computer may include other peripheral output devices, such as speakers, printers, etc.

The computer may operate in a networked environment using logical connections via wired and/or wireless communications to one or more remote computers. The remote computer(s) may be a workstation, a server computer, a router, a personal computer, a portable computer, a personal digital assistant, a cellular device, a microprocessor-based entertainment appliance, a peer device or other common network node, and may include many or all of the elements described relative to the computer. The logical connections depicted include wired/wireless connectivity to a local area network (LAN) and/or larger networks, for example, a wide area network (WAN). Such LAN and WAN networking environments are commonplace in offices, and companies, and facilitate enterprise-wide computer networks, such as intranets, all of which may connect to a global communications network such as the Internet.

The computer may be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi (such as IEEE 802.11x (a, b, g, etc.)) and Bluetooth™ wireless technologies. Thus, the communication may be a predefined structure as with a conventional network or simply an ad hoc communication between at least two devices.

The system may also include one or more server(s). The server(s) may also be hardware and/or software (e.g., threads, processes, computing devices). The servers may house threads to perform transformations by employing aspects of the invention, for example. One possible communication between a client and a server may be in the form of a data packet adapted to be transmitted between two or more computer processes. The data packet may include a cookie and/or associated contextual information, for example. The system may include a communication framework (e.g., a global communication network such as the Internet) that may be employed to facilitate communications between the client(s) and the server(s).

While exemplary embodiments have been set forth above for the purpose of disclosure, modifications of the disclosed embodiments as well as other embodiments thereof may occur to those skilled in the art. Accordingly, it is to be understood that the disclosure is not limited to the above precise embodiments and that changes may be made without departing from the scope. Likewise, it is to be understood that it is not necessary to meet any or all of the stated advantages or objects disclosed herein to fall within the scope of the disclosure, since inherent and/or unforeseen advantages of the may exist even though they may not have been explicitly discussed herein.

What is claimed is:

1. A system for administering insurance benefits, the system comprising:
a computer system;
one or more server systems in communication with the computer system; and
an administration portal provided on the one or more server systems, the administration portal being configured to provide information related to one or more predetermined insurance benefits packages, the information pertaining to coverage options available under the one or more predetermined insurance benefits packages;
wherein the administration portal is accessible by the computer system after the one or more predetermined insurance benefits packages have been selected, identified, or purchased.

2. The system of claim 1, wherein the administration portal is not accessible by the computer system before the one or more predetermined insurance benefits packages have been selected, identified, or purchased.

3. The system of claim 1, wherein the administration portal is configured to provide substantially real-time quote associated with the one or more predetermined insurance benefits packages based, at least in part, on input from at least one of a client, an insurance broker and a stored client profile.

4. The system of claim 1,
wherein the administration portal is configured to allow access to at least one document or form related to insurance administration; and
wherein the administration portal is configured to transmit the at least one document or form to the computer system upon request.

5. The system of claim 4, wherein the administration portal is configured to receive an executed form from the computer system and to transmit the executed form to at least one of an insurance broker, an insurance company, a third party administrator, a government agency, a financial institution and a debit/credit card processor.

6. The system of claim 1, wherein the administration portal is in communication with a forms component, the forms component including a forms library database and an auto-populated forms component, the auto-populated forms component being configured to automatically pre-fill at least some data into at least one form provided to the computer system by the administration portal.

7. The system of claim 1,
wherein the computer system includes a client computer system; and
wherein the administration portal is in communication with a banking institution and a third party administrator.

8. The system of claim 7, wherein the banking institution is associated with administration of at least one of a health debit card account and a health saving account.

9. An administration portal for insurance benefits, the administration portal comprising:
an administration portal front end, the administration portal front end being configured to communicate with at least one computer system via a network;
an administration portal management database operatively connected to the administration portal front end; and
at least one content database including data associated with at least one of available coverage selections, rate schedules, client profiles, quote reports, and provider searches pertaining to a previously purchased insurance benefit;
wherein the administration portal front end is configured to communicate with the at least one computer system after the previously purchased insurance benefit has been purchased.

10. The administration portal of claim 9, wherein the computer system comprises at least one of a broker computer system and a client computer system.

11. The system of claim 9, wherein the administration portal is not accessible by the computer system before the previously purchased insurance benefits have been purchased.

12. A computer-readable medium including program code for implementing a method, the method comprising:
after selling a selected insurance benefit to a client, providing a computer-accessible administration portal, the computer-accessible administration portal providing at least one of information and documents associated with the selected insurance benefit, the information and documents including at least one available selection or change of insurance coverage available under the selected insurance benefit.

13. The computer-readable medium of claim 12, wherein the at least one of the information and documents includes a quote generated substantially in real-time based at least in part on data pertaining to the selection or change of insurance coverage provided under the selected insurance benefit.

14. The computer-readable medium of claim 12, wherein providing the computer-accessible administration portal includes providing information associated with at least one of health care providers, pharmacies, pharmaceuticals, health and wellness, government benefits, broker service centers, and insurance company service centers.

15. The computer-readable medium of claim 12, wherein the method comprises transmitting, to the client via the administration portal, a form including at least some pre-filled data.

16. The computer-readable medium of claim 15, wherein the method comprises receiving, from the client via the administration portal, an executed version of the form.

17. The computer-readable medium of claim 12, wherein the method comprises at least one of collecting, storing, and analyzing at least one of health records, health account balances, account claims, and health-related data.

18. The computer-readable medium of claim 12, wherein the method comprises establishing a chat session between at least two of a client, a broker, and an insurance company representative via the computer-accessible administration portal.
